(19) United States
(12) Patent Application Publication
(10) Pub. No.: US 2026/0210787 A1
(43) Pub. Date: Jul. 23, 2026

(54) METHOD FOR CALIBRATING MULTI-AXIS FORCE TORQUE SENSOR, AND APPARATUS THEREFOR

(71) Applicant: KYUNGPOOK NATIONAL UNIVERSITY INDUSTRY-ACADEMIC COOPERATION FOUNDATION, Daegu (KR)

(72) Inventor: Min Young KIM, Daegu (KR)

(21) Appl. No.: 19/158,202

(22) PCT Filed: Feb. 15, 2024
(86) PCT No.: PCT/KR2024/095234

§ 371 Date: Aug. 20, 2025

(30) Foreign Application Priority Data
Feb. 20, 2023 (KR) 10-2023-0022008

(51) Int. Cl. G01L 25/00; G01L 5/00; G01L 5/1627

(52) U.S. Cl. CPC G01L 25/003; G01L 5/0066; G01L 5/1627

(57) ABSTRACT

A method for calibrating a sensor of a multi-axis force/torque sensor, which has a maximum of n axes, measures a force in a vertical direction on the n/2 axes, and measures a torque in a horizontal direction on the n/2 axes, includes: a first step of preparing test reference data of the multi-axis force/torque sensor; a second step of obtaining sensor output values measured on the n axes provided in the multi-axis force/torque sensor by using the test reference data prepared in the first step as an input value; a third step of calculating a linear relationship between an input value and a sensor output value on each axis for a force and a torque by using the sensor output values obtained in the second step; and a fourth step of calculating an input value corresponding to the sensor output value obtained in the second step based on the linear relationship calculated in the third step, to calculate a correlation equation for a correlation between each axis.

### TECHNICAL FIELD

The present invention relates to a method for calibrating a multi-axis force/torque sensor and an apparatus according to the same, and more particularly, to a method for calibrating a multi-axis force/torque sensor and an apparatus according to the same, wherein the multi-axis force/torque sensor is designed to ensure linearity with respect to each axis, but in practice, linearity of each axis is not independent, and thus the independence of each axis is ensured through matrix modification and optimization of the multi-axis calibration matrix using an input/output matrix equation.

### BACKGROUND ART

In general, with the development of technology, robots have an increasingly similar structure to humans and are able to imitate human movements. One of the most important things in making the robot as described above is to execute the desired operation by distributing accurate force to the robot according to the situation.

In order to accurately distribute the force to the robot, a force/torque sensor, also known as a force sensor, has been developed due to the need to precisely measure the force/torque applied between the frames of the robot, and additionally, a multi-axis force/torque sensor that simultaneously measures the force in multiple axes has been developed.

FIG. 1 is a diagram illustrating a conventional resistive force/torque sensor, and as illustrated, the resistive force/torque sensor is configured in a form in which a three-dimensional structure is formed and several strain gages (SGs) are attached to the structure. When an external force is applied to the structure of the resistance type force/torque sensor as described above, the length of the strain gage changes, and a resistance value that changes in proportion to it is measured and calculated as a force or torque value.

In addition to the resistance type force/torque sensor described above, a spring type force/torque sensor has also been proposed. A spring-type force/torque sensor is a device that forms a structure having a spring, measures the displacement of the spring that changes when an external force is applied to the structure, and converts it into force or torque.

Since such existing sensors require a complex three-dimensional structure, it is difficult to make the sensor small and thin, and there is a problem in that it is difficult to apply it to a part with spatial constraints. In addition, since high technology is required for processing a structure, attaching a gage, and calibrating a measurement value, there is a problem in that the price of a sensor becomes expensive, and commercialization has been difficult due to the above problems.

Korean Patent No. 10-1470160 (Title of Invention: Flat Type Force/Torque Sensor) shown in FIG. 2 to which a representative technology proposed to solve the above problems is attached, the flat type force/torque sensor includes a first substrate 100 including N (N is a natural number) first electrodes E1, a second substrate 200 including N second electrodes E2 facing the first electrodes, and a dielectric D positioned between the first substrate and the second substrate.

In addition, the first substrate 100 and the second substrate 200 are made of a PCB substrate, and the first electrode E1 and the second electrode E2 are formed on the surface of the PCB substrate in contact with the dielectric, so that the electrodes are in close contact with the dielectric when the dielectric and each substrate are coupled, and the first electrode E1 and the second electrode E2 facing each other, and the dielectric D positioned between the first electrode and the second electrode facing each other form N sensor cells.

The sensor cells formed as described above are divided into NFSC (Normal Force Sensor Cell, NE1, NE2) for measuring a force in the vertical direction and SFSC (Shear Force Sensor Cell, SE1, SE2) for measuring a force in the horizontal direction.

In addition, the normal force sensor cells NFSC and the shear force sensor cells SFSC are formed in half in each of the N sensor cells, and each of the sensor cells is alternately positioned on the outer circumferential surfaces of the circular plate-shaped dielectric D and the substrates 100 and 200.

In this case, a sensor value regarding a force is detected by the NFSC (Normal Force Sensor Cell, NE1, NE2), and a sensor value regarding a torque is detected by the SFSC (Shear Force Sensor Cell, SE1, SE2).

The multi-axis force/torque sensor (FT sensor) illustrated in FIG. 1 or FIG. 2 described above does not have a problem in itself, and there is a difference in use of the multi-axis force/torque sensor, and in order to perform robotic control by actually using the multi-axis force/torque sensor, an essential process called sensor calibration must be carried out.

This is because the cell data value of the sensor cell constituting the multi-axis force/torque sensor does not have the same value as the actual physical quantity, and thus when the value of the cell data treated as equal to the actual physical quantity, precise control of the robotics becomes impossible.

Therefore, the process of determining the correspondence between the value measured by the multi-axis force/torque sensor and the actual physical quantity is necessary, and this is the process of calibrating the sensor.

When the sensor calibration is performed, the cell data of the reference multi-axis force/torque sensor providing the reference data value is used, and since the cell data of the calibrated multi-axis force/torque sensor, which is the force sensor performing the calibration, and the cell data of the reference multi-axis force/torque sensor do not have a linear distribution, the calibration was performed using only a local portion having linearity in the related art, and thus the range of data measurable by the sensor is limited, and it is difficult to secure the accuracy of the measured value.

In addition, as shown in FIGS. 1 and 2, the multi-axis force/torque sensor is a sensor having a maximum 6-axis degree of freedom of output according to each axis and each torque direction in a 3D space, and although a method of calibrating each axis in order to solve the above-described problem is well known, as described above, force torque sensing data output from the maximum 6-axis has a correlation that affects each other.

Therefore, since the conventional sensor calibration method for calibrating only each axis of the maximum 6 axes does not take into account the signal correlation of the multi-axis force/torque sensor having the maximum 6-axis degree of freedom of output, it is difficult to meet the demands of the robotic control site requiring precise control.

### PRIOR ART LITERATURE

### Patent Document

(Patent Document 01) Publication No. 10-2008-0039624
(Patent Document 02) Registered Patent 10-1470160

### DETAILED DESCRIPTION OF THE INVENTION

### Technical Problem

The present invention has been made in an effort to provide a method for calibrating a multi-axis force/torque sensor, and more particularly, to a method for calibrating a multi-axis force/torque sensor and an apparatus therefor, wherein the multi-axis force/torque sensor is designed to ensure linearity with respect to each axis, but in practice, the linearity of the each axis is not independent, and thus the independence of the each axis is guaranteed through matrix modification and optimization of the multi-axis calibration matrix using an input/output matrix equation.

### Technical Solution

In order to achieve the above-described object, a method for calibrating a multi-axis force/torque sensor according to the present invention, which has a maximum of n axes, measures forces in a vertical direction on the n/2 axes, and measures torques in a horizontal direction on the n/2 axes, includes: a first step of preparing reference data for testing of the multi-axis force/torque sensor; a second step of obtaining sensor output values measured on the n axes provided in the multi-axis force/torque sensor by using the reference data for testing prepared in the first step as an input value; a third step of calculating a linear relationship between input values and sensor output values on each axis for forces and torques by using the sensor output values obtained in the second step; and a fourth step of calculating an input value corresponding to the sensor output values obtained in the second step based on the linear relationship calculated in the third step, and then calculating a correlation equation according to a correlation between each axis.

In order to achieve the above object, the method for calibrating the multi-axis force/torque sensor according to the present invention further includes a fifth process of determining reliability by calculating an integrated calibration value according to a matrix vector for integrated calibration of correlations between respective axes based on the correlation matrix calculated through the fourth process.

As an additional feature of the calibration method of a multi-axis force/torque sensor according to the present invention for achieving the aforementioned purpose, the third process is to generate n linear functions using a linear regression method based on the minimization of a square error for each of the n axes.

As an additional feature of the calibration method of a multi-axis force/torque sensor according to the present invention for achieving the aforementioned purpose, the function according to the linear relationship is a function of y=ax+b, x is an input value of force or torque applied to each axis, y is an output value of each sensor according to the input value, the slope (a) is calculated by

$$a = \frac{n \sum ( {x}_{i} {y}_{i} ) - \sum {x}_{i} \sum {y}_{i}}{n \sum {( {x}_{i} )}^{2} - {( \sum {x}_{i} )}^{2}} ,$$

and the intercept (b) is calculated by b=y̅−a·x̅.

As an additional feature of the calibration method of a multi-axis force/torque sensor according to the present invention for achieving the aforementioned purpose, the method comprises: a first step of storing the sensor output values yᵢ of all axes after applying xᵢ to each axis being tested; a second step of generating and storing an estimated value x′ᵢ of xᵢ by using a function based on the linear relationship derived in the third process from all the output values yᵢ of the axes; a third step of defining, when the estimated values x′ᵢ are generated for each axis of the multi-axis force/torque sensor through the second step, an estimated value vector X′=[x′₁, x′₂, . . . , x′ₙ] and a true value vector of calibration values Z′=[x₁, x₂, . . . xₙ]; and a fourth step of implementing an integrated calibration matrix equation Z=RX′+P based on the estimated value vector X′ and the true value vector Z defined through the third step.

As an additional feature of the calibration method of a multi-axis force/torque sensor according to the present invention for achieving the aforementioned purpose, when the integrated calibration matrix equation is in the form of Z=RX′+P, if for each data pair the vectors Z and X′ are defined such that the vectors corresponding to data pair j are Zⱼ and X′ⱼ, then when there are n data pairs, the vectors Z₁ through Zₙ and X′₁ through X′ₙ exist. A first step comprises newly defining [X′, 1] as \hat{X} and rearranging the integrated calibration matrix equation Z=RX′+P into the form Z=[R P]*\hat{X}=U*\hat{X}. A second step comprises reorganizing the calibration matrix equation obtained in the first step such that the matrices of Z₁ through Zₙ and the newly defined \hat{X} are arranged as T=[Z₁, Z₂ . . . Zₙ] and Q=[ [symbol] , [symbol] . . . [symbol] ], and finally converting it into T=U*Q. A third step comprises, from the calibration matrix equation converted in the second step, defining and arranging U=[R P], and obtaining the correlation coefficient R and the correlation constant P through the relation U=TQ′×(QQ′)⁻¹.

As an additional feature of the calibration method of a multi-axis force/torque sensor according to the present invention for achieving the aforementioned purpose, the fifth process may further include a first step of calculating the vector X′=[x′₁, x′₂, . . . , x′ₙ] of the estimated value using the sensor output information generated from all measured axes of the multi-axis force/torque sensor and the linear regression function calculated through the third process; a second step of calculating the integrated calibration matrix vector Z=[x₁, x₂, . . . , xₙ] from the calibration matrix formula Z=RX′+P calculated through the fourth process based on the vector X′=[x′₁, x′₂, . . . , x′ₙ] of the estimated value calculated through the first step; and a third step of reading whether the multi-axis force/torque sensor is corrected or not based on the integrated calibration value Z=[x₁, x₂, . . . , xₙ] calculated through the second step.

As a feature of the calibration apparatus for a multi-axis force/torque sensor according to the present invention for achieving the aforementioned purpose, in a sensor calibration apparatus for a multi-axis force/torque sensor having up to n axes, configured such that n/2 axes measure force in the vertical direction and n/2 axes measure torque in the horizontal direction, the apparatus comprises: a test reference data DB storing test data for testing the multi-axis force/torque sensor; a test pressurizing unit for applying force or torque to each axis of the multi-axis force/torque sensor corresponding to the data values provided by the test reference data DB; a multi-axis sensor value detection and storage unit for individually detecting and storing, for each axis, the sensor values output from the multi-axis force/torque sensor in response to the force or torque applied by the test pressurizing unit; a multi-axis linear function generation unit for calculating the linear relationship between input values of force and torque and the sensor values on each axis by using the sensor values stored in the multi-axis sensor value detection and storage unit; and an inter-axis correlation matrix generation unit for calculating a correlation matrix equation according to the correlation between axes by first calculating the input values corresponding to the sensor output values acquired through the multi-axis sensor value detection and storage unit based on the linear function derived by the multi-axis linear function generation unit, and then comparing the calculated input values with the actual input values generated from the test reference data DB.

In order to achieve the above object, the apparatus for calibrating a multi-axis force/torque sensor according to the present invention further includes an inter-axis correlation matrix equation reliability checking unit for determining reliability by calculating an integrated calibration value according to a matrix vector for integrally calibrating the correlation between each axis based on the correlation matrix equation calculated through the inter-axis correlation matrix equation generating unit.

In order to achieve the above object, the multi-axis linear function generation unit generates n linear functions for each of the n axes using a linear regression method based on the minimization of a square error; the function according to the linear relationship is a function of y=ax+b; x is an input value of a force or torque applied to each axis, y is an output value of each sensor according to the input value, the slope (a) is calculated by

$$a = \frac{n \sum ( {x}_{i} {y}_{i} ) - \sum {x}_{i} \sum {y}_{i}}{n \sum {( {x}_{i} )}^{2} - {( \sum {x}_{i} )}^{2}} ,$$

and the intercept (b) is calculated by b=y̅−a·x̅ the input value.

As an additional feature of the calibration apparatus for a multi-axis force/torque sensor according to the present invention for achieving the aforementioned purpose, the inter-axis correlation matrix generation unit stores the sensor output values yᵢ of all axes after applying xᵢ to each axis under test, and then generates and stores an estimated value x′i of xi by using a function based on the linear relationship derived in the third process from all the output values yᵢ of the axes. When the estimated values x′ᵢ are generated for each axis of the multi-axis force/torque sensor through the second step, an estimated value vector X′=[x′₁, x′₂, . . . , x′ₙ] and a true value vector of calibration values Z=[x₁, x₂, . . . , xₙ] are defined. Based on the defined estimated value vector X′ and the true value vector Z, an integrated calibration matrix equation Z=RX′+P is implemented.

In order to achieve the above-described object, when the integrated calibration matrix is a Z=RX′+P-shaped matrix equation, when Z and X′ vectors existing in each pair of data are defined as vectors Zⱼ and X′ⱼ matching the data pair j, if there are n data pairs, Z₁ to Zₙ and X′₁ to X′ₙ vectors exist, and [X′, 1] is newly defined as A to arrange the integrated calibration matrix Z=RX′+P as Z=[R P]*\hat{X}=U*\hat{X}, and the arranged calibration matrix is further organized such that the matrices of Z₁ to Zₙ and the newly defined \hat{X} are expressed as T=[Z₁, Z₂ . . . Zₙ] and Q=[ [symbol] , [symbol] . . . [symbol] ], and finally converted into T=U*Q. Then, in the calibration matrix equation converted as above, by defining and arranging U=[R P], the correlation coefficient R and the correlation constant P are obtained through the relation U=TQ′×(QQ′)⁻¹.

As an additional feature of the calibration apparatus for a multi-axis force/torque sensor according to the present invention for achieving the aforementioned purpose, the inter-axis correlation matrix reliability inspection unit calculates an estimated value vector X′=[x′₁, x′₂, . . . , x′ₙ] by using the sensor output information generated from all axes measured by the multi-axis force/torque sensor together with the linear regression function derived through the third process. Based on the calculated estimated value vector X′=[x₁, x′₂, . . . , x′ₙ], an integrated calibration matrix vector Z=[x₁, x₂, . . . , xₙ] is calculated from the calibration matrix equation Z=RX′+P, and based on the calculated integrated calibration value Z=[x₁, x₂, . . . , xₙ], the reliability of the calibration of the multi-axis force/torque sensor is determined.

### Advantageous Effect

According to the present invention, the multi-axis force/torque sensor is designed to ensure linearity with respect to each axis, but since linearity of each axis is not actually independent, the multi-axis force/torque sensor has an effect of ensuring the independence of each axis through the matrix equation and optimization of the multi-axis calibration matrix using the input/output matrix equation.

### DESCRIPTION OF DRAWINGS

FIG. 1 is an exemplary view of a conventional resistive force/torque sensor

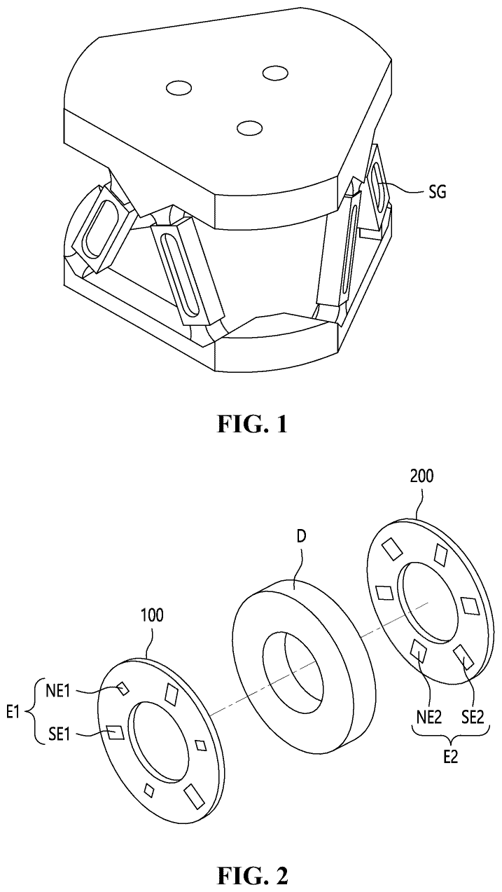

FIG. 2 is an exploded perspective view of a conventional planar force/torque sensor

FIG. 3 is a block diagram of an apparatus for applying a calibration method of a multi-axis force/torque sensor according to the present invention

FIG. 4 is a schematic flowchart for explaining a method of calibrating a multi-axis force/torque sensor according to the present invention

FIG. 5 is an exemplary diagram for explaining a linear regression method used in the present invention

FIGS. 6 and 7 are detailed flow diagrams of a calibration process of the multi-axis force/torque sensor according to the present invention shown in FIG. 4

### MODE FOR INVENTION

Hereinafter, a calibration method of a multi-axis force/torque sensor according to the present invention and a device thereof will be described with reference to the accompanying drawings.

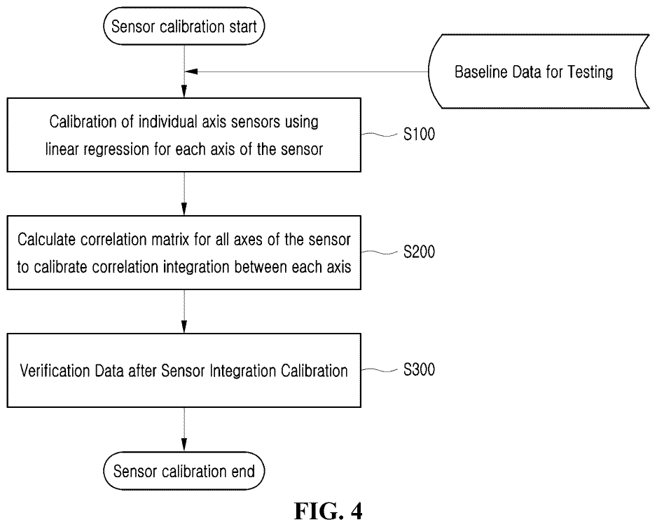

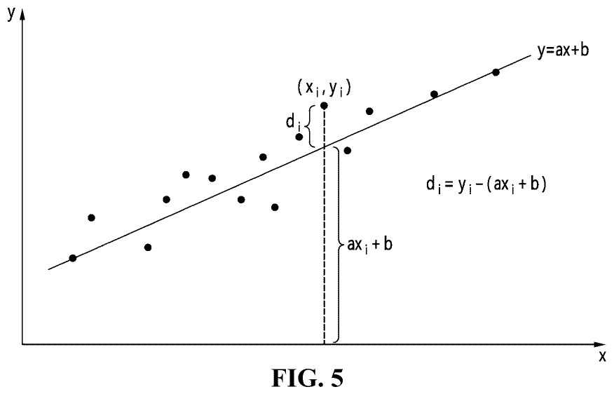

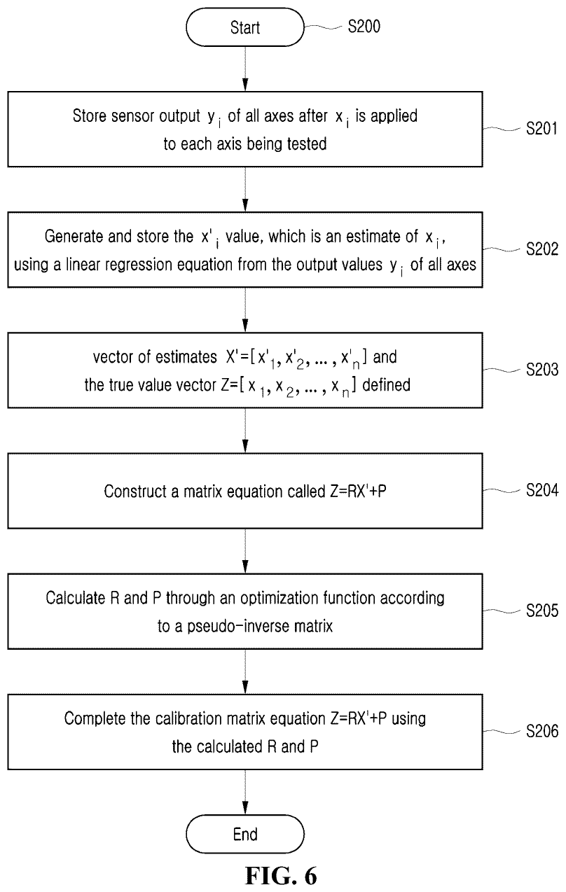

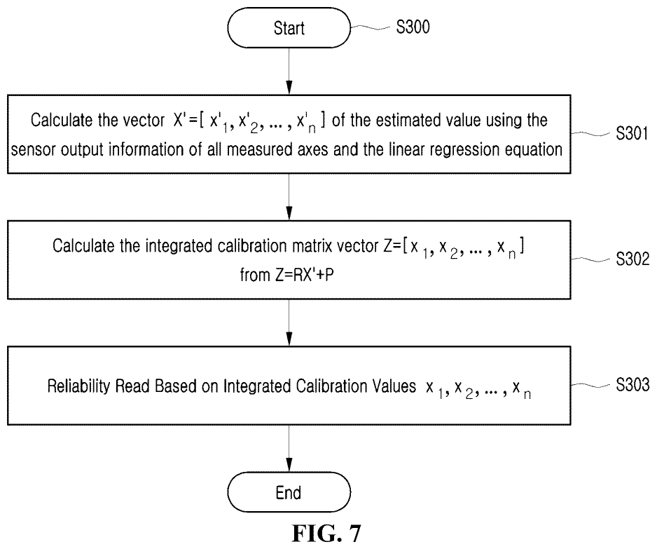

FIG. 3 is a block diagram of an apparatus for applying a method of calibrating a multi-axis force/torque sensor according to the present invention, FIG. 4 is a schematic flowchart for explaining a method of calibrating a multi-axis force/torque sensor according to the present invention, FIG. 5 is an example diagram for explaining a linear regression method used in the present invention, and FIGS. 6 and 7 are detailed flow diagrams of a calibration process of a multi-axis force/torque sensor according to the present invention shown in FIG. 4.

As illustrated in FIG. 3, the apparatus for calibrating a multi-axis force/torque sensor according to the present invention includes a reference data DB 20 for testing, which stores data for testing the multi-axis force/torque sensor, assuming that the multi-axis force/torque sensor 10 has a maximum of n axes, measures forces in a vertical direction on the n/2 axes, and measures torque in a horizontal direction on the n/2 axes, a pressurization unit 30 for testing, which applies forces or torques to each axis of the multi-axis force/torque sensor 10 in response to a data value provided from the reference data DB 20 for testing, a multi-axis sensor value detection storage unit 40 for individually detecting and storing sensor values output from the multi-axis force/torque sensor 10 according to the forces or torques applied by the pressurization unit 30 for testing The present invention comprises: a multi-axis linear function generation unit (50) for calculating a linear relationship between a sensor value and an input value on each axis for force and torque by using stored sensor values; an inter-axis correlation matrix generation unit (60) for calculating an input value corresponding to a sensor output value obtained through the multi-axis sensor value detection storage unit (40) on the basis of the linear function calculated by the multi-axis linear function generation unit (50), and then comparing the calculated input value with an actual input value generated by the test reference data (DB) (20) to calculate a correlation matrix according to a correlation between each axis; and an inter-axis correlation matrix reliability checking unit (70) for calculating an integrated calibration value according to a matrix for integrally calibrating the correlation between each axis on the basis of the correlation matrix calculated by the inter-axis correlation matrix generation unit to determine reliability.

Referring to the operation of the apparatus for calibrating the multi-axis force/torque sensor according to the present invention, that is, the calibration method, as illustrated in FIG. 4, the method for calibrating the multi-axis force/torque sensor according to the present invention uses the test reference data for each axis constituting the multi-axis force/torque sensor as an input value in the process of step S100 to generate y=ax+b, which is a linear function using linear regression, and calibrates each individual axis sensor through the generated linear regression function.

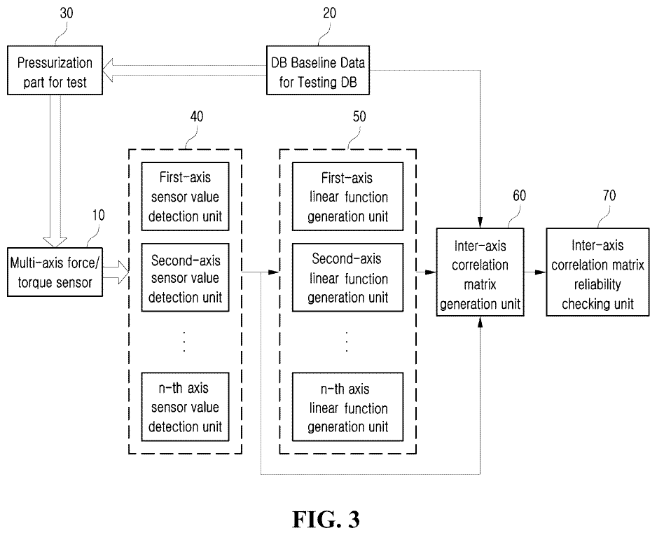

In this case, assuming that the multi-axis force/torque sensor illustrated in FIG. 2 is used, the multi-axis force/torque sensor performs calibration on the sensor values of the three force sensors and the three torque sensors, and obtains a total of six linear regression functions corresponding to the sensor values, respectively.

Thereafter, in step S200, an input value corresponding to the sensor output value is calculated based on the linear relationship calculated through the step S100, the calculated input value is compared with the actual input value, a correlation matrix according to the correlation between each axis is calculated, and the correlation between each axis is integrated and calibrated based on the correlation matrix.

Substantially, the calibration method for securing the independence of the output linearity of the multi-axis force/torque sensor according to the present invention may include the process of step S100 and the process of step S200, and the process of step S300 is a verification process for the calibration method for securing the independence of the output linearity of the multi-axis force/torque sensor according to the present invention described above.

Referring to FIG. 5, in which the process of obtaining the linear regression function calculated in the process of step S100 is attached, the points expressed in FIG. 5 represent (x, y) ordered pairs for the output value y for the input value x, and the purpose of the linear regression method is to obtain y=ax+b, which is a linear function representing each point.

In this case, the linear equation y=ax+b is a straight line in the xy plane, a and b are constants, and x and y are real numbers.

It is important to note that when each point forms a single formula, a reasonable straight line is created for each point so that the deviation is minimized. This is called a linear regression method based on ‘minimization of square error’ (hereinafter referred to as the least squares method).

As shown in the accompanying FIG. 5, the least squares method is a method of defining vertical deviations of points x and y that are ordered pairs and obtaining straight line y=ax+b so that the sum thereof is minimized, and the slope a and the intercept b are determined according to this method.

Looking at the basic rules for obtaining a straight line through the least squares method, for the straight line to be finally obtained, the deviation between the straight line and points is minimized to obtain one straight line representing the data obtained from the experiment.

The ‘only solution,’ or a single equation, can be obtained if the sum of squares is used to calculate the error of the data.

Therefore, when the vertical deviation (et: the same as di in the attached FIG. 5) and the total sum S of the vertical deviation are defined as an equation, it may be summarized as the below Equation 1.

$${e}_{i} = {γ}_{i} - ( a {x}_{i} + b ) = {γ}_{i} - a {x}_{i} - b \qquad [ Equation 1 ]$$

$$S = {\sum }_{i = 1}^{n} {e}_{i}^{2} = {\sum }_{i = 1}^{n} {( {γ}_{i} - a {x}_{i} - b )}^{2}$$

At this time, the slope (a) and intercept (b) of the straight line must be calculated, and differentiation, a basic mathematical tool for obtaining the minimum error, is applied to obtain the slope and intercept.

Since S, which is the total sum of vertical deviations, is a multivariate function composed of the total sum of squares of individual vertical deviations et, two partial derivative functions such as Equations 2 and 3 below may be obtained by partial derivative of the total sum of vertical deviations S by a and b, respectively.

$$\frac{\partial S}{\partial a} = - 2 \sum [ ( {y}_{i} - a {x}_{i} - b ) {x}_{i} ] \qquad [ Equation 2 ]$$

$$\frac{\partial S}{\partial b} = - 2 \sum ( {y}_{i} - a {x}_{i} - b ) \qquad [ Equation 3 ]$$

When the total vertical deviation S is differentiated (partial derivative) and the point at which the total vertical deviation S is minimized (i.e., the point at which the derivative of S is zero) is found, the point at which the error is minimized may be found, and this is a process of using the ‘least square method’.

A derivation process for a point at which the value of the partial derivative function according to Equation 2 becomes zero is summarized as Equation 4 below.

$$\frac{\partial S}{\partial a} = - 2 \sum [ ( {y}_{i} - a {x}_{i} - b ) {x}_{i} ] \qquad [ Equation 4 ]$$

$$\to 0 = - 2 \sum [ ( {y}_{i} - a {x}_{i} - b ) {x}_{i} ]$$

$$\to 0 = \sum [ ( {y}_{i} - a {x}_{i} - b ) {x}_{i} ]$$

$$\to 0 = \sum ( {x}_{i} {y}_{i} ) - a \sum {( {x}_{i} )}^{2} - b \sum {x}_{i}$$

$$⇒ 0 = \sum ( {x}_{i} {y}_{i} ) - a \sum {( {x}_{i} )}^{2} - b \sum {x}_{i} ( From \frac{δ S}{δ a} )$$

In addition, a derivation process for a point at which the value of the partial derivative function according to Equation 3 becomes zero is summarized as Equation 5 below.

$$\frac{\partial S}{\partial b} = - 2 \sum ( {y}_{i} - a {x}_{i} - b ) \qquad [ Equation 5 ]$$

$$\to 0 = - 2 \sum ( {y}_{i} - a {x}_{i} - b )$$

$$\to 0 = \sum ( {y}_{i} - a {x}_{i} - b )$$

$$\to 0 = \sum {y}_{i} - a \sum {x}_{i} - n b$$

$$⇒ 0 = \sum {y}_{i} - a \sum {x}_{i} - nb ( From \frac{δ S}{δ b} )$$

The slope (a) and the intercept (b) of the straight line may be obtained based on Equations 4 and 5, and the slope (a) is obtained as in Equation 6 below, and the intercept (b) is obtained as in Equation 7.

$$a = \frac{n \sum ( {x}_{i} {y}_{i} ) - \sum {x}_{i} \sum {y}_{i}}{n \sum {( {x}_{i} )}^{2} - {( \sum {x}_{i} )}^{2}} \qquad [ Equation 6 ]$$

$$b = \overline{y} - a \cdot \overline{x} \qquad [ Equation 7 ]$$

It is possible to obtain a reasonable linear function y=ax+b representing the experimental data through the least squares method based on the slope (a) and intercept (b) according to Equations 6 and 7.

Therefore, in the case of the multi-axis force/torque sensor illustrated in FIG. 2, which is attached to the multi-axis force/torque sensor for sensor calibration, since a linear function may be obtained for each of the three force sensors located on three axes and the three torque sensors located on three axes, a total of six linear regression functions corresponding to the sensor values provided on each axis may be obtained.

Based on a total of six linear regression functions calculated in the process of step S100 through the above-described process, the process of step S200 stores the sensor output values yᵢ of all axes after xᵢ is applied to each axis tested in step S201, as shown in FIG. 6.

In step S202, the x′ᵢ value, which is an estimate of xᵢ, is generated and stored using the linear regression equation calculated in the process of step S100 from the output values yᵢ of all axes.

When an x′ᵢ value, which is an estimate, is generated in step S202 for each axis of the multi-axis force/torque sensor, in step S203, a vector X′=[x′₁, x′₂, x′₃, x′₄, x′₅, x′₆] of the estimate and a true value vector of the calibration value are defined as Z=[x₁, x₂, x₃, x₄, x₅, x₆].

After that, in step S204, a matrix equation called Z=RX′+P is constructed, where R is the correlation coefficient 6×6 matrix and P is the offset constant vector.

Therefore, in step S205, in order to complete the matrix equation constructed in step S204, R and P are calculated using various optimization functions including pseudo-inverse matrices.

In this case, briefly looking at the pseudo-inverse matrix, when the correlation equation is a matrix equation in the form of Z=RX′+P, it is necessary to derive the pseudo-inverse matrix to obtain R and P. That is, when there are vectors Z and X′, the purpose is to obtain R and P together.

Since each pair of data has vectors Z and X′, if we define them as vectors Zⱼ and X′ⱼ that match the data pair j, if there are n pairs of data, there are vectors from Z₁ to Zₙ and from X′₁ to X′ₙ.

Therefore, this is summarized in Equation 8 below.

$$\begin{matrix}{Z}_{1} = R {X}_{1}^{′} + P \\ {Z}_{2} = R {X}_{2}^{′} + P \\ … \\ {Z}_{n} = R {X}_{n}^{′} + P\end{matrix} \qquad [ Equation 8 ]$$

At this time, a new \hat{X} is defined, and the new \hat{X} is [X′, 1].

Therefore, when Equation 8 is redefined as a new \hat{X}, it may be summarized as Z=[R P]*\hat{X}=U*\hat{X}. In this case, U=[R P] is defined.

Using this, a matrix as shown in Equation 9 below is defined.

$$T = [ {Z}_{1} {Z}_{2} … {Z}_{n} ] \qquad [ Equation 9 ]$$

$$Q = [ \text{?} … \text{?} ]$$

When the matrix as shown in Equation 9 is summarized, it may be finally defined as T=U*Q, where T is a 6×n matrix and Q is a 7×n matrix. U is a 6×7 matrix.

Finally, by deriving the correlation coefficient R and the correlation constant P, a solution as shown in Equation 10 below may be obtained.

$$U = T {Q}^{′} \times {( Q {Q}^{′} )}^{- 1} \qquad [ Equation 10 ]$$

At this time, since U=[R P] is defined, R is a 6×6 matrix and P is a 6×1 vector in the 6×7 matrix of U.

When the correlation coefficient R and the correlation constant P are calculated through the above-described process, the calibration matrix formula Z=RX′+P is completed through the process of step S206.

When the integrated sensor calibration is performed based on the calibration matrix calculated in the process of step S200 through the above-described process, the process of step S300 is performed, and as shown in FIG. 7, the vector X′=[x′₁, x′₂, x′₃, x′₄, x′₅, x′₆] of the estimated value is calculated using the sensor output information of all axes measured in the process of step S301 and the linear regression equation.

Thereafter, in step S302, the integrated calibration matrix vector Z=[x₁, x₂, x₃, x₄, x₅, x₆] is calculated from the calibration matrix equation Z=RX′+P calculated in step S200.

Thereafter, in the process of step S303, determine reliability based on the integrated calibration value Z=[x₁, x₂, x₃, x₄, x₅, x₆].

As described above, the multi-axis force/torque sensor is a sensor having a maximum of 6 axes of output freedom according to each axis and each torque direction in a three-dimensional space, and the calibration method for securing independence of output linearity of the multi-axis force/torque sensor according to the present invention is largely divided into two steps.

In the first step, linear calibration is performed on each axis using the verification test input value and the sensor output value. That is, the simplest method after performing the linear calibration is to obtain the yᵢ=Axᵢ+B (where the input is x and the outputs are y, A and B are linear coefficients) for the force and torque, and by using this, the y output during the actual test may be viewed, and the estimate of the input x, x′, may be obtained.

In the second step, the results are recorded by experimenting with what values the entire axis derives for the input of each axis. This experimental step is to record how the entire axis is affected for all axis inputs. When the entire experiment is completed, the input and output are expressed as equations using a correlation matrix.

The represented correlation matrix is arranged as Z=RX′.

Here, the estimated input vector X′ and the calibrated input estimation vector Z are maximum six-dimensional vectors, and R corresponds to a correlation matrix of maximum 6×6 that calibrates the correlation with each other. Various optimization methods may be used to estimate the correlation matrix, and simply, a pseudo inverse matrix method may be used, and various weight least squares method, LevenbergMarquardt matrix optimization and genetic algorithm, machine learning technique, and the like may be used.

Although the exemplary embodiments of the present invention have been illustrated and described above, the present invention is not limited to the specific embodiments described above, and various modifications can be made by a person having ordinary skill in the art to which the method belongs without departing from the gist of the present invention claimed in the claims, and such modifications should not be individually understood from the technical spirit or the prospect of the present invention.

1-13. (canceled)

14. A calibration method for a multi-axis force/torque sensor configured to have n axes and to have n/2 of the axes measure force in a vertical direction and n/2 of the axes measure torque in a horizontal direction, the method comprising:
preparing test reference data for the multi-axis force/torque sensor;
obtaining sensor output value measured on the n axes of the multi-axis force/torque sensor by inputting the test reference data as first input value;
calculating a linear relationship between the first input value and the sensor output value on each axis for forces and torques; and
calculating second input value corresponding to the sensor output value based on the linear relationship and calculating a correlation matrix equation according to correlations between respective axes by comparing the second input value with the first input value.

15. The calibration method of claim 14, further comprising verifying reliability by calculating an integrated calibration value according to an integrated calibration matrix vector for integrated calibration of correlation between each axis based on the correlation matrix equation.

16. The calibration method of claim 14, wherein the calculating a linear relationship further comprises generating n linear functions by using a linear regression function based on minimization of square errors for each of the n axes.

17. The calibration method of claim 16, wherein the linear relationship is defined by y=ax+b,
where x is the first input value of force or torque applied to each axis, y is the sensor output value of each sensor corresponding to the first input value, a slope (a) is calculated by
$$a = \frac{n \sum ( {x}_{i} {y}_{\dot{t}} ) - \sum {x}_{i} \sum {y}_{i}}{n \sum {( {x}_{i} )}^{2} - {( \sum {x}_{i} )}^{2}} ,$$
and an intercept (b) is calculated by b=y̅−a·x̅.

18. The calibration method of claim 14, wherein the calculating second input value comprises:
storing the sensor output value yᵢ of all axes after applying the first input value xᵢ to each axis under test;
generating and storing the second input value x′ᵢ of xᵢ by using a function based on the linear relationship from all the sensor output value yᵢ of the axes;
defining a second value vector X′=[x₁, x′₂, . . . x′ₙ] and a first value vector of calibration values Z=[x₁, x₂, . . . , xₙ]; and
implementing a correlation matrix equation Z=RX′+P.

19. The calibration method of claim 18, wherein, when the integrated calibration matrix equation is in the form of Z=RX′+P and when Z and X′vectors existing in each pair of data are defined as vectors Zⱼ and X′ⱼ matching the data pair j, the method comprises:
arranging the correlation matrix Z=RX′+P as Z=[R P]*\hat{X}=U*\hat{X}, where there are n data pairs, Z₁ to Zₙ and X′₁ to X′ₙ vectors exist and where [X′, 1] is newly defined as \hat{X};
reorganizing the arranged correlation matrix equation by arranging the matrices of Z₁ through Zₙ as T=[Z₁, Z₂ . . . Zₙ] and arranging the \hat{X} as Q=[ [symbol] , [symbol] . . . [symbol] ] and converting the arranged calibration matrix equation into T=U*Q; and
defining and arranging U=[R P] in the reorganized calibration matrix equation, and obtaining correlation coefficient R and correlation constant P through the relation U=TQ′×(QQ′)⁻¹.

20. The calibration method of claim 15, wherein the verifying reliability further comprises:
calculating a vector X′=[x′₁, x′₂ . . . , x′ₙ] of the second input value by using the sensor output value generated from all measured axes of the multi-axis force/torque sensor and a linear regression function;
calculating the integrated calibration matrix vector Z=[x₁, x₂ . . . , xₙ] from the correlation equation Z=RX′+P based on the vector X′=[x′₁, x′₂ . . . , x′ₙ] of the second input value; and
determining whether the multi-axis force/torque sensor is reliable based on the integrated calibration value Z=[x₁, x₂ . . . , xₙ].

21. A sensor calibration apparatus for a multi-axis force/torque sensor configured to have n axes and to measure a force in a vertical direction on n/2 axes and to measure a torque in a horizontal direction on n/2 axes, wherein n is an integer greater than or equal to 2, the sensor calibration apparatus comprising:
a test reference data DB configured to store test reference data for testing the multi-axis force/torque sensor;
a test pressurizer configured to apply a force or a torque to each axis of the multi-axis force/torque sensor in response to first input value provided from the test reference data DB;
a multi-axis sensor value detector and storage for individually detecting and storing sensor output values from the multi-axis force/torque sensor according to the force or torque applied by the test pressurizer for each axis;
a multi-axis linear function generator configured to calculate a linear relationship between the first input value and the sensor output value on each axis for forces and torques by using the sensor output value; and
an inter-axis correlation matrix generator configured to calculate a correlation matrix equation according to correlations between respective axes by calculating second input value corresponding to the sensor output value based on the linear relationship, and then comparing the second input value with the first input value.

22. The sensor calibration apparatus of claim 21, further comprising an inter-axis correlation matrix reliability tester configured to verify reliability by calculating an integrated calibration value according to an integrated calibration matrix vector for integrated calibration of correlations between respective axes based on the correlation matrix equation.

23. The sensor calibration apparatus of claim 21, wherein the multi-axis linear function generator generates n linear functions for each of the n axes using a linear regression function based on minimization of square errors,
where the linear relationship is defined by a function y=ax+b,
where x is the first input value of force or torque applied to each axis, y is the sensor output value corresponding to the first input value, a slope (a) is calculated by
$$a = \frac{n \sum ( {x}_{i} {y}_{i} ) - \sum {x}_{i} \sum {y}_{i}}{n \sum {( {x}_{i} )}^{2} - {( \sum {x}_{i} )}^{2}} ,$$
and a intercept (b) is calculated by b=y̅−a·x̅.

24. The sensor calibration apparatus of claim 23, wherein the inter-axis correlation matrix generator
stores the sensor output value yᵢ of all axes after the first input value xᵢ is applied to each axis under test;
generates and stores the second value x′ᵢ of xᵢ using a function based on the linear relationship calculated from the sensor output value yᵢ of all axes;
defines a second value vector X′=[x′₁, x′₂, . . . x′ₙ] and a first value vector Z=[x₁, x₂, . . . , xₙ] of calibration values; and
implements a correlation matrix equation Z=RX′+P based on the defined second value vector X′ and the first value vector Z.

25. The sensor calibration apparatus of claim 24, wherein, when the correlation matrix equation is in the form of Z=RX′+P, and the vectors Z and X′ in each data pair are defined as Zⱼ and X′ⱼ corresponding to the data pair j, and if there are n data pairs, the vectors Z₁ through Zₙ and X′₁ through X′ₙ exist, the sensor calibration apparatus is configured to:
rearrange the correlation matrix equation Z=RX′+P as Z=[R P]*\hat{X}=U*\hat{X}, where [X′, 1] is newly defined as \hat{X};
reorganize the rearranged correlation matrix equation by arranging the matrices of Z₁ through Zₙ as T=[Z₁, Z₂ . . . Zₙ] and arranging the \hat{X} as Q=[ [symbol] , [symbol] . . . [symbol] ] and convert into T=U*Q; and
define U as [R P] and obtain the correlation coefficient R and the correlation constant P according to the relation U=TQ′×(QQ′)⁻¹.

26. The sensor calibration apparatus of claim 22, wherein the inter-axis correlation matrix reliability tester
calculates a vector X′=[x′₁, x′₂, . . . , x′ₙ] of the second value using the sensor output value generated from all measured axes of the multi-axis force/torque sensor and a linear regression function generated by the multi-axis linear function generator,
calculates an integrated calibration matrix vector Z=[x₁, x₂, . . . , xₙ] from the correlation matrix equation Z=RX′+P based on the calculated vector X′=[x′₁, x′₂, . . . , x′ₙ] of the second input value, and
determines whether the multi-axis force/torque sensor is reliable based on the calculated integrated calibration value Z=[x₁, x₂, . . . , xₙ].
